(19) United States
(12) Patent Application Publication
(10) Pub. No.: US 2004/0186750 A1
(43) Pub. Date: Sep. 23, 2004

(54) Method and system for automating insurance processes

(76) Inventors: Gordon Surbey, Easton, CT (US); Timothy Wright, London (GB); Anthony Siggers, East Sussex (GB); Howard Green, Surrey (GB); Adam Sandler, New York, NY (US)

Correspondence Address: MICHAEL N. HAYNES, 1341 HUNTERSFIELD CLOSE, KESWICK, VA, 22947, US

(21) Appl. No.: 10/391,533

(22) Filed: Mar. 18, 2003

(51) Int. Cl. G06F 17/60

(52) U.S. Cl. 705/4; 715/501.1; 715/530; 715/513

(57) ABSTRACT

A method is disclosed for creating a customized folder structure for a web-enabled collaborative insurance process. The method includes, for each of a plurality of users, automatically creating a plurality of standardized folders consistent with a role of the user in a web-enabled collaborative insurance process. The method also includes, automatically hierarchically organizing the plurality of standardized folders into a folder structure and providing the user with access via a networked computer to the user's hierarchically organized folder structure and plurality of standardized folders.

### CROSS-REFERENCE TO RELATED APPLICATION

This application claims priority to pending PCT Application PCT/US01/29767, filed 24 Sep. 2001, which claims priority to U.S. Provisional Application Serial No. 60/234,368, filed Sep. 22, 2000.

### FIELD OF THE INVENTION

The present invention relates to the field of computer software specifically designed for risk management and insurance, and, more particularly, to a method and system for web-enabling the risk management and insurance process.

### BRIEF DESCRIPTION OF THE DRAWINGS

The invention will be more readily understood through the following detailed description, with reference to the accompanying drawings, in which:

FIG. 1 is a flowchart of an embodiment of a method 100 of the present invention;

FIG. 2 is a block diagram of an embodiment of a system 200 of the present invention;

FIG. 3 is a block diagram of an embodiment of an information device 300 of the present invention;

FIG. 4 is a flowchart of an embodiment of a method 400 of the present invention;

FIG. 5 is a flowchart of an embodiment of a graphical user interface 500 of the present invention;

FIG. 6 is a flowchart of an embodiment of a method 600 of the present invention;

FIG. 7 is a flowchart of an embodiment of a method 700 of the present invention;

FIG. 8 is a block diagram of an embodiment of a system 800 of the present invention; and

FIG. 9 is a block diagram of an embodiment of a software architecture 900 of the present invention.

### DETAILED DESCRIPTION

Overview

The $600 billion risk and insurance industry occupies a vital role in the global economy by making it possible for businesses to quantify, manage, hedge, and transfer risks. The industry has enormous growth opportunities as the demand for risk management spreads from traditional exposures like fire, flood, and public liability to hedging financial and other specialized risks.

The industry is predominantly populated by four major types of participants: clients who transfer risk to insurers or sometimes manage their own risks through special purpose vehicles; insurers who accept risk in return for a premium; brokers who work as intermediaries on behalf of clients to provide risk management advice, structure transactions, and place those transactions in the market; and other risk solution providers, like accounting firms and consultants, who generally provide advice only.

The industry has evolved to provide custom solutions to clients who have uniquely different risk management needs. As once explained to a young broker by a venerable Lloyd's underwriter, “what we do here, young man, is tailor hand-made suits”. The “hand-made suits” analogy conveys an important point about today's property and casualty insurance industry—the idea that customization can only be achieved by craftwork—experienced people working within networks of trusted colleagues and relying upon tried and tested paper methods.

The industry has indeed achieved the ability to customize products and services, but at an enormous cost to its clients. Up to 20% of every premium dollar is wasted on inefficient and duplicative processes.

Many in the industry see technology as completely divergent to this handwork ideal. They cannot see how technology could add anything to processes that are highly personalized and unique. This is not surprising as most financial service technology successes are in those sectors that are commodity-like, such as personal lines of credit, mortgages, or term life. The result is that technology has little impact on the production and distribution of commercial insurance. In fact, it is estimated that 99% of the interactions in this $400 billion industry continue to rely entirely on paper methods.

Thus, the market is characterized by enormous inefficiency due to a reliance on antiquated paper methods. The entire process depends upon the creation, copying, distribution, tracking, and archiving of masses of paper documents and messages of all types.

But what if there were technologies that could enhance customization, enabling the customer to be measured more accurately, fitted more closely, and offered a greater selection of cloth than ever before possible? What if the customer could check on progress and make adjustments between fittings and could engage his far-flung advisors to help him select the best styles?

Although most brokers and insurers have “back office” computer systems that keep accounting, contract, and statistical records, there is virtually no “front end” technology to support interactions with clients, structuring the transaction, and/or placing the transaction into the market. For example, of the top global 200 brokers and insurers, only a handful have technology that systematically manages documents and interactions.

Recent studies, such as those by Goldman Sachs and Swiss Re, estimate that savings of $45 billion are possible by e-business enabling the “front end” of the industry. There are two enormous barriers to capturing these benefits. First, large insurers and brokers traditionally build their own technology platforms, while smaller players rely upon specialist software vendors who have only partially web-enabled their software. It will take too long and cost too much if each participant attempts to web-enable their processes using proprietary methods. Second, e-business efficiencies rely upon inter-operability, and proprietary systems militate against such inter-operability.

Thus, the industry needs a new approach that provides access to state-of-the-art e-business software at low cost, without considerable development risks, and with immediate availability and scalability to any number of users. At the same time, the industry needs the promotion of inter-operability via standardizing on a common e-business platform and harnessing the industry standards that do exist.

A business model associated with embodiments of the present invention can provide software that is tailored to the specific needs of the risk management and insurance industry to harness the efficiencies of e-business without the cost, risk, and delays of building proprietary systems. The software can wrap around existing systems that have been widely deployed in the industry such as e-mail and desktop office software.

Moreover, embodiments of the present invention can provide collaborative e-business technologies that enable more efficient and deeper customization. Such technologies can work by enhancing the traditional skills of the industry as opposed to replacing them. These technologies also can leverage the talents of key people by substantially freeing them of paperwork and can enhance the service provided to clients by promoting them from spectators to full participants.

To see how this could work, consider the following fictitious, yet exemplary scenario. Janet Smith is the risk manager of Global Inc. a rapidly growing multi-national company operating in 64 countries. Janet felt that her previous insurance broker had treated her as a bystander. Although she had access to their extranet for accounting and some policy detail information, she could only get intermittent status reports on key assignments like renewals and major claims. She looked for a new broker who would make her and her team a part of the process. Vision Company was one of the first brokering firms to adopt collaborative e-business and this was a important reason they won the Global account just before the July renewal of the global property program.

Vision had made a big push to integrate all its files and records into the document management system that was one component of the collaborative platform. Andy Stewart, Vision's account executive, had set-up folders in the system mirroring the paper files he would have kept tucked away in the rows of filing cabinets that previously monopolized his floor space. Andy had selected an account team and had appointed someone in each of the Vision offices to be involved in servicing the local needs of Global. Andy set up a “global property renewal” folder and started uploading the documents and information that would be needed to negotiate the renewal. As the fifty or so Vision people who will work on the Global account log-on to their computers, they will see and have access to the files Andy has created. Unlike e-mail, where dozens of different versions are created, here only one version of each file is available, which everyone on the team has access to and works with collaboratively.

Guided by Janet, Andy Stewart has identified people that will co-ordinate risk management in each of Global's locations and, at the click of a mouse, has included more than a hundred Global people in the “property renewal” community. The system will automatically notify each one of their inclusion, and will provide them with a unique and secure password so they can access the system using nothing more than an Internet connection. As they log-on they see a “property folder” containing information and instructions concerning the renewal. This folder includes a template to collect risk exposure information that they must check-out of the folder and enter up-to-date property and business interruption values. The template has been tagged in the background using XML, a technology that enables the entered information to be read by any insurer's computer without re-keying. In the meantime, Andy has posted instructions to each of the local Vision brokers telling them what to do about local DIC (differences in coverage) and primary coverages. Janet and her risk management team have real-time access to these files, can see exactly what is happening, and can interact at any time.

Andy has created a “draft manuscript” policy and has given access to Janet and her core team, and to her internal and external lawyer. Any member of this group can make edits to the electronic draft and those edits are immediately visible to the rest of the team. The system keeps track of every version of the document and who has authored it. Although not typically visible in the folder, old versions of the document can be recalled at any time.

Andy now begins to assemble an electronic submission using the completed exposure templates, draft manuscript wording, and other relevant documents. He uses the tools provided by the system to select potential insurers. Andy and Janet plan to visit potential underwriters and negotiate lead positions face-to-face. The electronic submission is supported by an audit trail that keeps track of exactly what documents, document versions, and messages have been exchanged with each of the potentially dozens of insurers that will be approached before this transaction is completed. This audit trail is added to potentially tens of thousands of documents and messages and Janet considers this reliable audit trail a crucial feature in replacing the certainty of paper.

In between the face-to-face sessions, Andy has provided Janet with access to a placement status report so she and her team can see every iteration and/or up-to-the-minute status at any time. Whenever an insurer responds with a quote or a question, this status report is updated. Janet doesn't need to see iteration in the process, she leaves this to her broker, and has agreed with Andy beforehand the level of detail required.

As the insurer's quotes are received, Andy and Janet can see the detail simultaneously and can discuss the issues with the full file in front of them even though Janet is traveling extensively and logging-in remotely. Andy is able to bind the insurers on-line and post a copy of the finally agreed wording in the folder.

Andy works with the lead insurer to create a new summary of coverages and incident reporting procedures that is posted in the client folder and instantly made available to all Global's representatives. Andy now adds the insurer's local representatives into the community so that everyone involved in the risk management (more than 400 people) can share the same information, communicate, and interact. In the background, the system automatically keeps a complete record of all of this interaction.

This exemplary story illustrates the opportunity to modernize risk services and solutions delivery by keeping customization yet adding collaboration, inclusion, and the efficiency of paperless processes.

Of course, this all sounds compelling but hasn't the insurance industry been littered with failed information technology projects, isn't it going to cost the earth, take forever, and be awfully risky to obtain these capabilities? The truthful traditional answer is “yes”.

Embodiments of the present invention, however, can apply a new approach for accessing technology called the Application Service Provider (ASP) model and/or the Central Host model. One idea behind this technology is that instead of hundreds of participants in an industry each building their own proprietary software at great risk and expense the central hoster will develop the software once and make it available to anyone in the industry based on a rental or (user subscription) model.

This approach can have huge advantages for an industry like risk management and insurance. First, and most important, it can promote inter-operability. If everyone uses that same basic infrastructure, then the holy grail of inter-operability can be achieved. Second, it can remove risk and dramatically shorten timeframes. This means that things can move much more quickly. Third, it can be scalable, meaning that any number of users can be added at the click of a mouse; one team today, another next week. Fourth, it can be greatly cheaper than “build your own” alternatives, because the development cost can be spread over far greater communities of users and can eliminate the need for expensive on-site computer installations. The evolution of the Internet has made central hosting possible by providing a ubiquitous “pipeline” through which users anywhere in the world can access and use the software.

Thus, centrally-hosted, collaborative e-business holds the potential for breakthrough improvements in client relationship management, thereby enabling brokers and insurers for the first time to be highly differentiated based upon their client service delivery.

By creatively recognizing, building, and assembling such collaborative tools, embodiments of the present invention can provide a number of advantageous functionalities.

Functionality #1—Folder Structure

Embodiments of the present invention can include software that incorporates an electronic folder structure that is customized to the risk management and insurance process. Via this software, a folder structure can be uniquely rendered to each user, thereby providing an always-current view of the folders and folder contents that the user has either created or been invited to access through the collaboration feature. One way of visualizing this is an electronic filing cabinet that can provide the user with instant access to any file they have created or are entitled to access. These files can be accessed anywhere/anytime through an Internet connection. The folder structure can have these features:

The folder hierarchy can be determined by the user's role. For example, if the user is a broker, the root folders can be associated with clients, as in “client A”, “client B”, and “client C”. If the user is a client, then the root folder can be associated with one or more brokers and/or insurers as in “broker A”, “insurer B”, and/or “broker C”.

The folder hierarchy can include standard sub-folders determined by the user's role. This feature can place a set of standard sub-folders under each folder, and can work with other functionalities to ensure that documents and interactions used in certain parts of the process are systematically filed in the correct standard folder. One purpose of this feature is to ensure that all of the documents and messages associated with a particular transaction can always be re-constituted by finding and opening a specific standard sub-folder. It also ensures that everybody in a team stores their documents and information in a consistent manner.

Functionality #2—Collaboration

Embodiments of the present invention can include software that allows a user to initiate collaboration with any number of other users both within their own organization or externally. Once the user sets up this “virtual community”, the collaborators can share documents, interact, and structure and manage transactions, subject to access rules set by the user.

Collaborations can be initiated at the level of a folder (for example, a client folder) or at any sub-level down to a specific document. By clicking on the folder (“explorer”) bar, the user can select the appropriate folder and folder level, and then can utilize the collaboration dialog tool to select collaborators. There can be two ways to select collaborators. If a collaborator has used the software previously then that collaborator can appear in the searchable directory of users. Alternately, the user can enter the collaborator's e-mail address and/or other details. New collaborators can be invited at any time in the course of a transaction or assignment.

The software can enable the user to set “access rights” with respect to each collaborator. Those access rights can identify, specify, and/or determine whether the collaborator can “read only”, “edit”, and/or “delete” documents.

Once the user has selected collaborators and chosen access rights, the software can provide a verification screen. If the user proceeds, the software can automatically send an “invitation” to each of the selected collaborators. This invitation can be an e-mail message that provides the URL (web address) of the unique workspace that the software has rendered for each collaborator, the workspace containing only those folders to which that collaborator has been granted access. In certain embodiments, all a collaborator needs is a web browser (e.g., Microsoft's Internet Explorer 5) and Internet access. The e-mail message can point the collaborator to a dialogue where they can set their own unique password to access the workspace. All collaborators can be notified every time there is an addition to a folder or a change to a document in a folder to which they have access.

Functionality # 3—Audit Trail

Embodiments of the present invention can include software that systematically keeps track of every collaboration, document, message, and/or interaction, thereby providing a complete and reliable “memory”. A complete audit trail can be permanently maintained and can be called-up at any time. An important feature is that “memory” is corporate, that is to say, it keeps track of every document by every member of a team and also keeps track of every interaction between every member of the team and/or third parties. Team members can be located anywhere in the world. The audit trail can be achieved in five ways:

The software can keep track of every version of every document and can provide a dialog box stating information about each version, such as the author and date created.

The software can keep track of every collaborator and their access rights.

The software can enable the user to see if and when a collaborator has opened a specific message or document. A dialog box can let the user verify the time and date a document or message was opened by a collaborator.

Message threads can provide a complete view of every interaction between collaborators in a given community. The collaboration “owner” can grant access rights that enable a third party to view the dynamic message thread. For example, a client may be granted access to view a thread developing between a broker and several insurers negotiating a risk placement.

As explained in functionality #2, standard folders can ensure that the documents and messages associated with a given transaction have a defined place in the folder hierarchy, and are always filed in that defined place.

Functionality #4—Templates

Embodiments of the present invention can include software that incorporates templates that can be used to enter structured information or data, and enable that information to be re-used by collaborators and/or counterparties (such as insurers) without re-keying. The templates can use a technology that can tag data items so they can be recognized by other computers, such as XML. For example, the information contained in the data field “name of the insured” could be tagged so that any computer using XML rules would recognize this information as the insured's name. XML tagged templates can enable structured information to be entered once (by, for example, the client) and “streamed” to all of the parties that need use of that information, without re-keying.

Use of templates can also advantageously provide flexibility because users can create their own templates depending on their needs. Templates can be created, for example, in a spreadsheet product, such as Excel, provided by Microsoft Corporation of Redmond, Wash.

In addition, the software can incorporate standard templates tagged using industry-wide standards, such as for example, those developed by ACORD (an industry standards body). These standard templates can initially embody the ACORD risk exposure standards. For example, if a user is providing a schedule of properties, property values, and business interruption values, then a standard template could be used to provide this “locations & values” schedule.

Thereby, a template user can publish the information entered into the template to the community of collaborators and track who enters additional information into the template, who modifies information in the template, and when those events occur.

Functionality #5—Process and Workflow Management

Embodiments of the present invention can include software that provides a user with a step-by-step process to structure transactions, such as a quote requests or claims notifications. The software can use structured messages to organize the process into a series of iterative steps.

For example, a “quote request” dialog can first prompt a user to select the appropriate client folder and the standard “negotiations” sub-folder. A dialog screen then can prompt the user to select the insurers to receive the quote request. The user can either search for appropriate insurers in the directory or can select an underwriter by entering their e-mail address. The dialog then can prompt the user to create an electronic submission by assembling documents such as exposure templates, word documents, and/or spreadsheets. In addition, there can be a veneer or header of structured information, such as inception date, expiration date, category of coverage, that can be entered or selected from a pick list by the user. The user can access these documents from any source within their computer, their network, or the web, and can upload them into the submission. The user also can add notes and instructions to the insurers. Once completed, the software can provide a verification screen. If the user accepts the contents of the submission, then an e-mail can automatically be sent to each of the chosen underwriters inviting them to access the electronic submission and supporting messages. Thereafter, each underwriter can access a uniquely rendered workspace, as explained in functionality #2.

Functionality #6—Status

Embodiments of the present invention can include software that provides a screen whereby all transactions being worked upon by the user are rendered as dynamically updated line items showing, for example, the client name, type of policy, and renewal date. Each line item can have a flag that shows the current status of the transaction, for example “sent for quote”, “quoted”, and/or “declined”. By clicking on any line item, the user can drill down to the thread of messages or documents associated with that item, such as for example, to the message or document sent by the underwriter providing details of the quote. Using a dialog box, the user can set preferences for the order and structure of the information displayed within the status screen.

Thus, embodiments of the present invention can provide one or more software packages designed to make the risk management and insurance process more efficient by web-enabling and/or enhancing antiquated paper processes, and/or by facilitating web-based collaboration between the parties. The software can be designed for use by any party to the risk management and insurance process, including clients, brokers, insurers, and/or other risk solution providers. As use of the software becomes widespread, the market can also achieve the goal of inter-operability. For example, the software can incorporate functionality for the straight-through-processing of transactions using, for example, XML tagging.

Moreover, embodiments of the present invention can provide a computer-aided method for managing a web-enabled and/or computerized collaborative insurance process. The method can include, for each of a plurality of insurance transactions, for each of a plurality of users, automatically creating a plurality of standardized computer document folders consistent with a role of the user in the collaborative insurance process, automatically hierarchically organizing the plurality of standardized computer document folders into a folder structure, and providing the user with access via a networked computer to the user's hierarchically organized folder structure and plurality of standardized computer document folders. The method can also include, for each of the insurance transactions, providing an insurance data entry template having a plurality of fields that meet an insurance industry standard for the computerized submission of exposure information, and receiving the insurance data entry template with data in each of the plurality of fields. The method can further include, for each of the insurance transactions, automatically creating a computer-based insurance quotation request based on the insurance data entry template and having a message and a document containing insurance requirements and exposure information, simultaneously sending the computer-based insurance quotation request to a plurality of insurers, and representing the insurance transaction as a hyperlinked line item on a computer display.

These and other embodiments can be further understood by reference to the Figures of the present patent application.

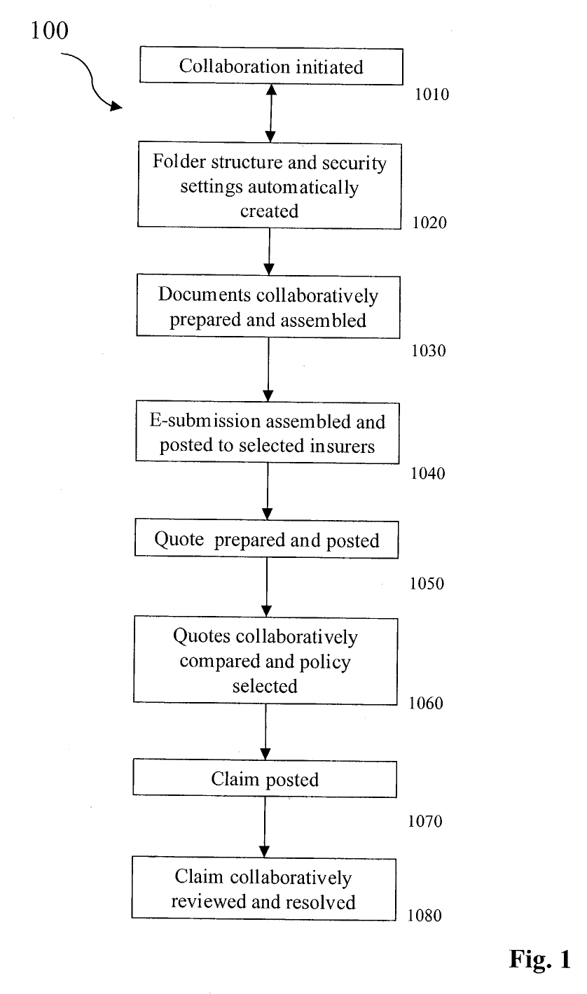

FIG. 1

FIG. 1 is a flowchart of an exemplary embodiment of an exemplary method 100 of the present invention. As shown at action 1010, method 100 can include the initiation of collaboration, which can be performed, for example, by a broker. In one embodiment, the broker can be the initiator, and collaborators can include the client, and the client's advisor (such as an attorney). By initiating collaboration, the initiator can identify, specify, indicate, and/or communicate the other collaborators.

At action 1020, a folder structure and security settings can be automatically created, as described above under Functionalities #1 and #2. In certain embodiments, the folder structure is created on-the-fly, on-demand, and/or as needed, to reflect the then-current folder hierarchy and the viewer's role.

At action 1030, documents can be collaboratively prepared. At action 1040, an electronic submission can be assembled and electronically posted to selected insurers. Actions 1030 and/or 1040 can be performed as described above under Functionalities #4 and/or #5. For example, a user can select a client folder and can specify insurers to whom a submission will be posted. To specify an insurer, the user can select the insurer from a directory of insurers, or can enter an e-mail address of the insurer. Then, an embodiment of a system of the present invention can prompt the user to create a submission by uploading and/or attaching documents to an “request for quotation” message. The user can provide a veneer of structured information, such as when quotes are due, to whom they should be provided, etc. The system can then prompt the user to verify that the entered structured information is correct.

Upon verification, the system can then provide the submission to the selected insurers. The submission can be provided by sending an e-mail message to the insurers, the e-mail message including an embedded URL link that points the insurer to the submission. In an alternative embodiment, the submission can be attached to the e-mail message.

At action 1050, at least some of the insurers can prepare and electronically post a quote. At action 1060, the broker, client, and/or client advisor can collaboratively compare the quotes and/or select a quoted policy.

At action 1070, the client, client advisor, and/or broker can post a claim. At action 1080, the client, client advisor, broker, and/or insurer can collaboratively review and/or resolve the claim.

Most, if not all, of actions 1010 through 1080 can be enhanced by Functionalities #3 and/or #6.

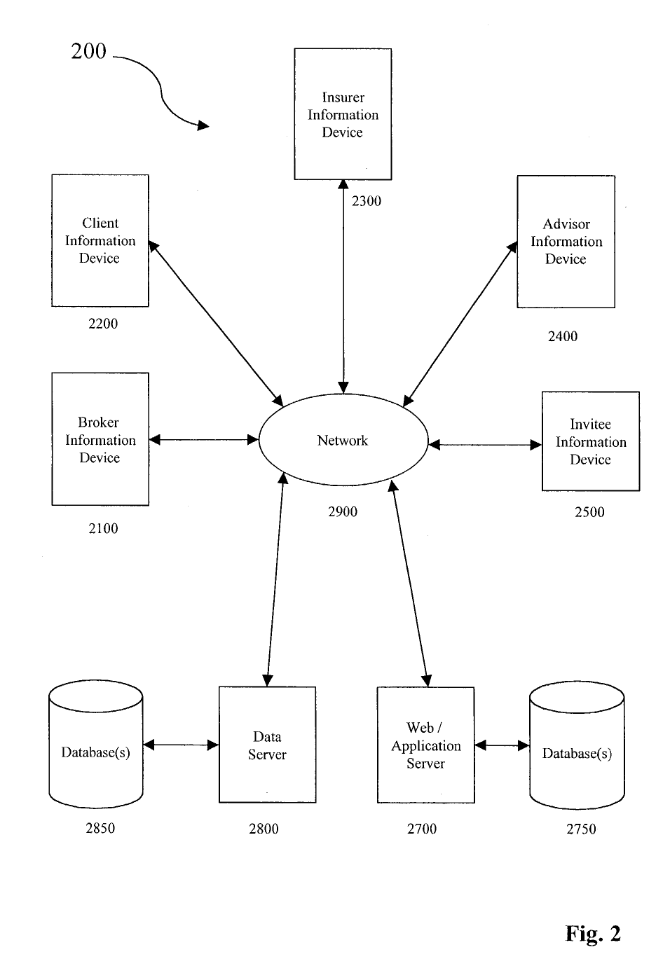

FIG. 2

FIG. 2 provides a block diagram of an exemplary embodiment of an exemplary system 200 of the present invention. As an initial matter, it suffices to say that, using the description of method 100, one of ordinary skill in the art can implement the functionality of method 100 via system 200 utilizing any of a wide variety of well-known architectures, hardware, protocols, and/or software. Thus, the following description of system 200 can be viewed as illustrative, and should not be construed to limit the implementation of method 100.

Within system 200, a broker information device 2100 can be used by a broker to communicate regarding one or more insurance transactions with various other information devices (e.g., client information device 2200, insurer information device 2300, etc.) and/or with one or more data servers 2700 and/or web/application servers 2800. Broker information device 2100 can also be used to collaborate with others, manage databases, query databases, enter transaction information, prepare an electronic submission, post the electronic submission, review quotes, select a policy, post a claim, review a claim, and/or resolve a claim, etc.

Broker information device 2100 can be connected to network 2900. Also connected to network 2900 can be various additional information devices 2200-2500, which can be used, for example, to collaborate with others, host databases, manage databases, query databases, enter transaction information, prepare an electronic submission, post the electronic submission, review the electronic submission, prepare a quote, post a quote, review quotes, select a policy, post a claim, review a claim, and/or resolve a claim, etc. As an illustrative example, an insurer information device can be used by an insurer to collaborate with others, host databases, manage databases, review an electronic submission, prepare a quote, post the quote, review a claim, and/or resolve a claim, etc.

Web/application server 2700 and/or data server 2800 also can be connected to network 2900 and can be used to host one or more databases 2750, 2850, serve files, serve e-mail, etc. Web/application server 2700 and/or data server 2800 can be one or more computing devices of any sort. Similarly, any of information devices 2100-2500 can be used to host one or more databases (not shown).

Network 2900 can electronically link physically distant information devices 2100-2500, web/application server 2700, and/or data server 2800, so that information can be transmitted and/or exchanged there between. Network 2900 can have any architecture, including a direct connection, a local area network, a wide area network such as the public switched telephone network and/or the Internet, an extranet, and/or a combination thereof. Network 2900 can be a packet-switched, a circuit-switched, a connectionless, or connection-oriented network or interconnected networks, or any combination thereof. Network 2900 can be oriented toward voice, data, or voice and data communications. Moreover, a transmission media of network 2900 can take any form, including wireline, satellite, wireless, or a combination thereof.

From a hardware standpoint, any information device 2100-2500, can be, for example, a landline or wireless telephone, facsimile, personal computer, personal information manager, personal digital assistant, handheld computer, data terminal, or other similar device.

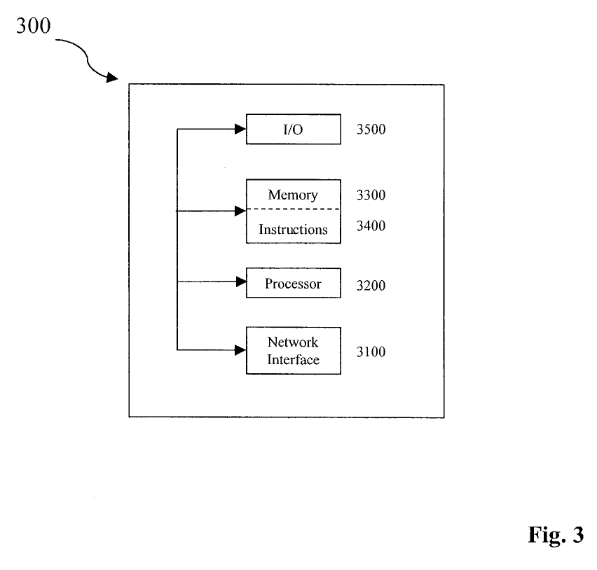

FIG. 3

FIG. 3 is a block diagram of a typical information device 300, which can symbolize any information device 2100-2500, and/or any server 2700, 2800. Information device 300 can include well-known components such as one or more network interfaces 3100, one or more processors 3200, one or more memories 3300 containing instructions 3400, and/or one or more input/output (I/O) devices 3500, etc..

In one embodiment, network interface 3100 can be a telephone, a traditional data modem, a fax modem, a cable modem, a digital subscriber line interface, a bridge, a hub, a router, or other similar devices.

Each processor 3200 can be a general purpose microprocessor, such the Pentium III series of microprocessors manufactured by the Intel Corporation of Santa Clara, Calif. In another embodiment, the processor can be an Application Specific Integrated Circuit (ASIC) which has been designed to implement in its hardware and/or firmware at least a part of a method in accordance with an embodiment of the present invention.

Memory 3300 can be coupled to a processor 3200 and can store instructions 3400 adapted to be executed by processor 3200 according to one or more actions of method 100. Memory 3300 can be any device capable of storing analog or digital information, such as a hard disk, Random Access Memory (RAM), Read Only Memory (ROM), flash memory, a compact disk, a magnetic tape, a floppy disk, and any combination thereof.

Instructions 3400 can be embodied in software, which can take any of numerous forms that are well-known in the art. For example, system 200 can utilize one or more databases having a flat file or a relational organization, and a centralized or distributed architecture. For instance, those of skill in the art can tailor items such as an SQL database to provide the functionality of method 100 and system 200. One supplier of such database items is Oracle Corporation, of Redwood Shores, Calif. Moreover, software tools such as EDI, FTP, HTTP, HTML, XML, cXML, XSL, and WAP can be utilized for communications between information devices. Additionally, system 200 can utilize platform-independent and/or network-centric software tools such as, for example, Java or JavaScript.

Any input/output (I/O) device 3500 can be an audio and/or visual device, including, for example, a monitor, display, keyboard, keypad, touchpad, pointing device, microphone, speaker, video camera, camera, scanner, and/or printer, including a port to which an I/O device can be attached or connected.

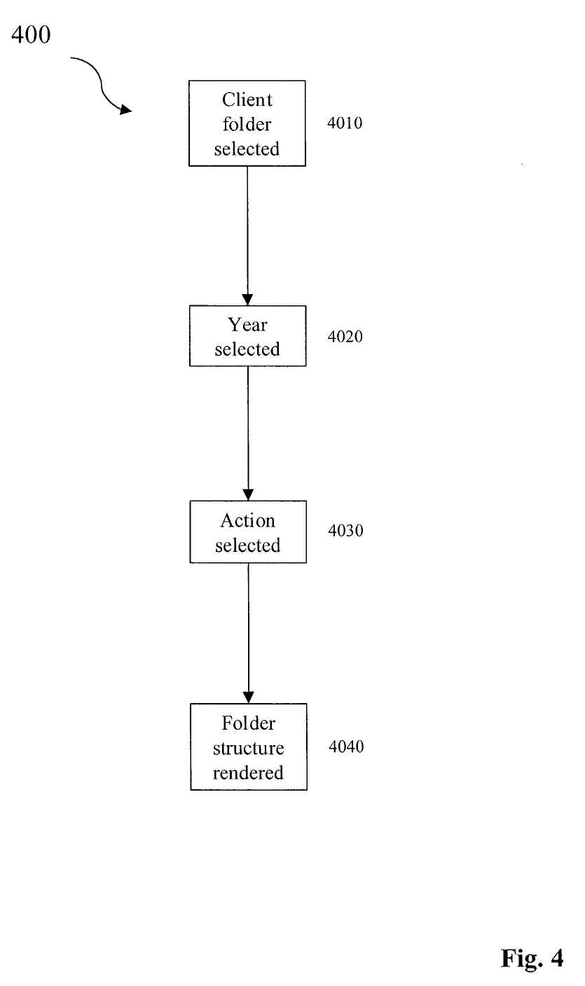

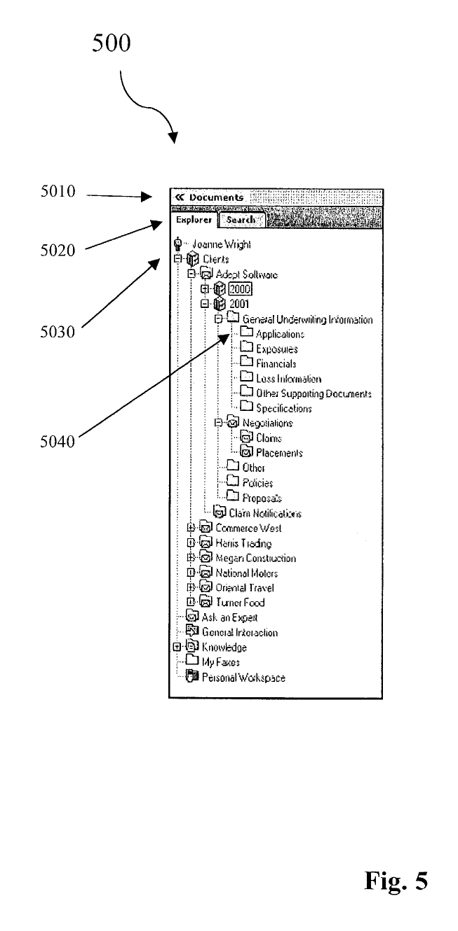

FIGS. 4 and 5

FIG. 4 is a flowchart of an exemplary embodiment of an exemplary method 400 of the present invention, and elaborates upon some of the possibilities of Functionality # 1. As shown at action 4010, method 400 can include the selection of a client folder by a user. At action 4020, the user can then select the applicable policy year. The current calendar year can be offered as a default. At action 4030, the user can select an action, such as for example, “negotiate renewal”. At action 4040, a system of the present invention can render to the user a folder structure that corresponds to the user's role and security settings.

FIG. 5 provides an example of a folder structure and/or graphical user interface 500 that can be rendered to a user by method 400 of FIG. 4. Window 5010 can contain one ore more tabs 5020. One such exemplary tab, titled “Explorer”, can allow a user to access a folder hierarchy 5030 directed to, for example, documents, messages, and/or templates. Another such exemplary tab, titled “Search”, can provide an interface whereby a user can search for one or more documents, messages, and/or templates, within folder hierarchy 5030, and/or view the results of that search.

Folder hierarchy 5030 can include one or more folders 5040, which, for example, can contain information about, and be titled, as follows:

“Clients”—documents, messages, and/or templates relating to identified clients;

“Ask an Expert”—an interface to communicate with experts regarding risk and/or insurance issues;

“General Interaction”—an interface to communicate with collaborators;

“Knowledge”—an interface to a knowledgebase regarding, for example, clients, industries, markets, competitors, and/or risk and/or insurance issues;

“My Faxes”—an interface for managing incoming and/or outgoing faxes; and/or

“Personal Workspace”—an interface for managing documents created and/or held by the user, etc..

Client folders 5040 can be further hierarchically organized by, for example:

Client name;

Policy year; and/or

Topics, such as:

“General Underwriting Infor mnation”;

“Negotiations”;

“Other”;

“Policies”; and/or

“Proposals”, etc..

Within a “General Underwriting Information” folder can be folders directed to, for example:

“Applications”;

“Exposures”;

“Financials”;

“Loss Information”;

“Other Supporting Documents”; and/or

“Specifications”, etc..

Within a “Negotiations” folder can be folders directed to, for example:

“Claims”; and/or

“Placements”, etc.

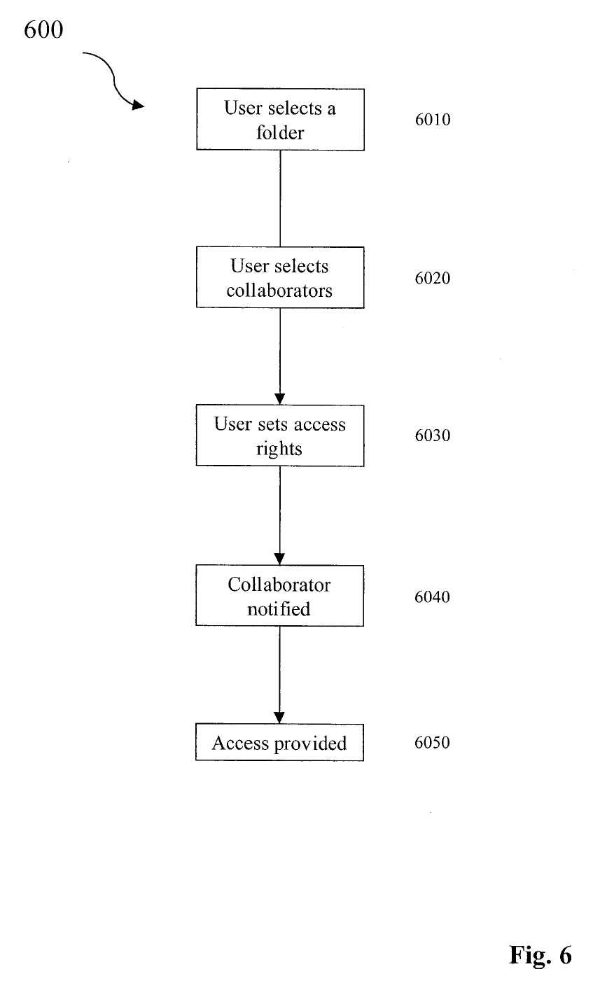

FIG. 6

FIG. 6 is a flowchart of an exemplary embodiment of an exemplary method 600 of the present invention, and elaborates upon some of the possibilities of Functionality #2. As shown at action 6010, method 600 can include the selection of a folder by a user. At action 6020, the user can then select the collaborators for the folder. The user can indicate these collaborators by any of several methods. For example, the user can search for the collaborator in a directory, and select the collaborator when found. As another example, the user can enter the collaborator's e-mail address.

At action 6030, the user can set access rights for the collaborators. These rights can be specified at any of several levels, including for all contents of the folder, for one or more sub-folders, and/or for one or more specific documents, messages, and/or templates within a given folder.

At action 6040, a system of the present invention can provide a notification to a collaborator of the change in access rights. For example, the system can send an e-mail message notifying a collaborator that they have been granted access to a particular client folder, and providing an embedded URL hyperlink, the activation of which can ultimately result in the rendering of the contents of that folder. As another example the system can send a pager message to a collaborator indicating that the collaborator has been upgraded from “read-only” to “read/write” access to a specific document. Thus, the system can provide notification via any known communications method and/or technology.

At action 6050, the system can respond to an attempt by the collaborator to exercise their access rights by presenting a log-in screen, the successful completion of which can result in the rendering of the folders to which access has been granted.

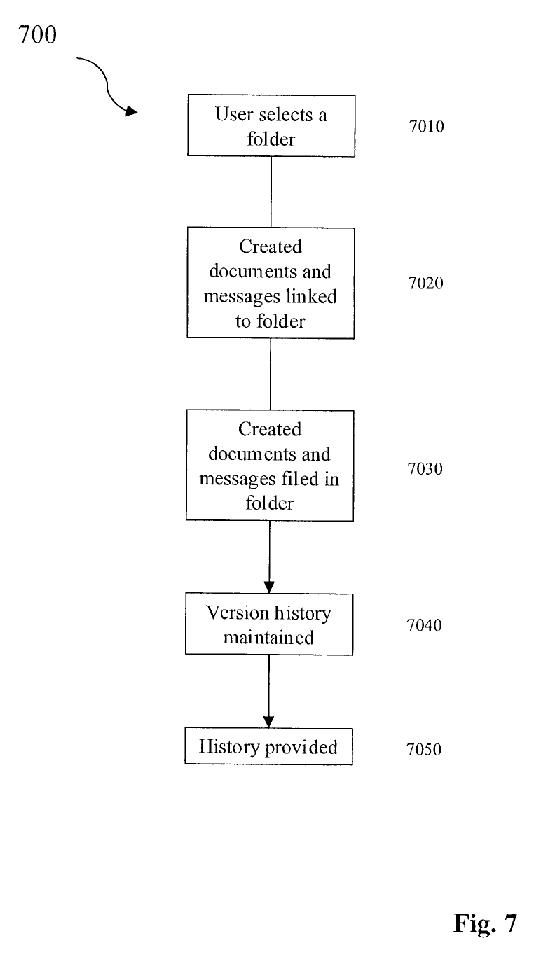

FIG. 7

FIG. 7 is a flowchart of an exemplary embodiment of an exemplary method 700 of the present invention, and elaborates upon some of the possibilities of Functionality #7. As shown at action 7010, method 700 can include the selection of a folder by a user. At action 7020, the user can then create documents and/or messages, which an embodiment of a system of the present invention can automatically link to the selected folder. At action 7030, an embodiment of a system of the present invention also can automatically store the created documents and/or messages in the selected folder. In an alternative embodiment, although the created documents and/or messages can be rendered to the user as being stored in the selected folder, the documents and/or messages can actually be stored on any networked media, with merely the link providing a connection to the rendered folder.

At action 7040, an embodiment of a system of the present invention can maintain a version history detailing any changes to a document or message. This version history can further describe the time and date of the changes, and the user performing the changes. Moreover, an embodiment of a system of the present invention can archive one or more earlier versions of the document or message, such that any version of the document or message can be recalled.

At action 7050, a history of the document and/or message can be provided to the user upon request. Also, the user can be notified when a collaborator has opened a message or document, and the time at which such opening occurred.

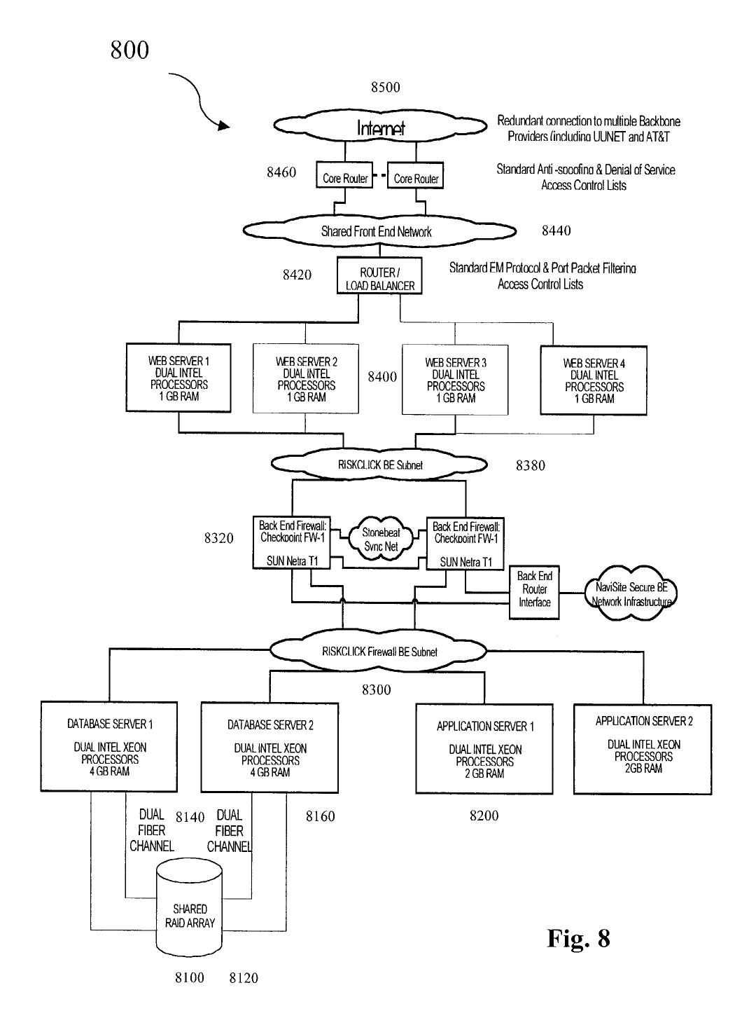

FIG. 8

FIG. 8 provides a block diagram of an exemplary embodiment of an exemplary system 800 of the present invention. As an initial matter, it suffices to say that, using the description of method 100 and/or functionalities #1 through #6, one of ordinary skill in the art can implement method 100 and/or functionalities #1 through #6 via system 800 utilizing any of a wide variety of well-known architectures, hardware, protocols, and/or software. Thus, the following description of system 800 can be viewed as illustrative, and should not be construed to limit the implementation of method 100 and/or functionalities #1 through #6.

Referring to FIG. 8, a database 8100 can be stored on a shared RAID array 8120, which can be connected via dual Fiber Channel 8140 to one or more database servers 8160. Each of database servers 8160 can include a dual Intel Xeon processor with 4 gigabytes of RAM, and can be connected through a back-end sub-network 8300 to one or more firewalls 8320.

Also connected through a back-end sub-network 8300 to one or more firewalls 8320 can be one or more application servers 8200, which can similarly include one or more Intel Xeon processors with a substantial quantity of RAM. Also, one or more databases (not shown) can be connected to application servers 8200.

Firewalls 8320 can run on one or more servers, such as the Netra T1 server, by Sun Microsystems Inc. of Palo Alto, Calif., and can utilize a secure backend network infrastructure such as those provided by Navisite of Andover, Mass. Firewalls 8320 can be clustered using one or more products from the StoneBeat line by StoneSoft of Helsinki, Finland. Firewalls 8320 can be connected via sub-network 8380 to one or more web servers 8400, each of which can utilize dual Intel processors with 1 gigabyte of RAM.

Web servers 8400 can be connected to a router/load balancer 8420 which can utilize standard EM protocol, port packet filtering, and/or access control lists. Router 8420 can be connected to a front-end network 8440, which can be connected to one or more core routers 8460, each of which can utilize standard anti-spoofing, denial of service counter-measures, and access control lists. Moreover, each of core routers 8460 can be connected to a data network 8500, such as the Internet. The connection to network 8500 can be redundant, and network 8500 itself can be a backbone provider, such as UUNET or AT&T.

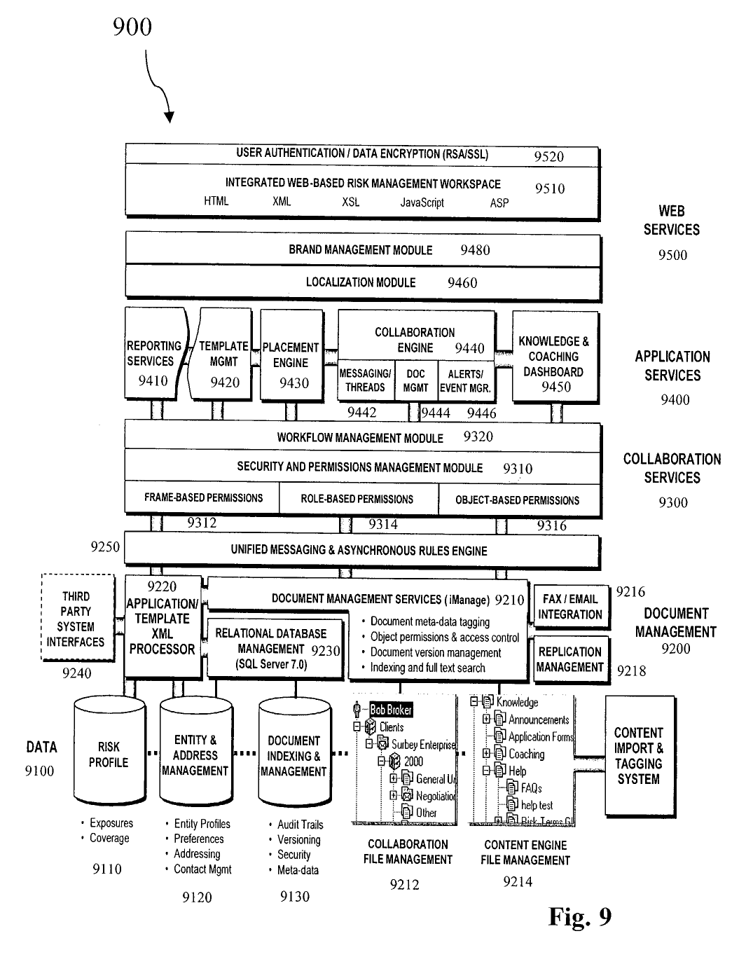

FIG. 9

FIG. 9 is a block diagram of an exemplary embodiment of an exemplary software architecture 900 of the present invention. Software architecture 900 can have several levels, including, for example, data level 9100, document management level 9200, collaboration services level 9300, application services level 9400, and/or web services level 9500, etc..

Included in data level 9100 can be numerous databases. For example, data level 9100 can include risk profile database 9110, which can include data related to exposures and/or coverages. Data level 9100 can also include an entity and address management database 9120, which can include data related to entity profiles, preferences, addressing, and/or contact management. Data level 9100 can also include a document indexing and management database 9130, which can include data related to audit trails, versioning, security, and/or meta-data.

Included in document management level 9200 can be a document management service 9210, such as the iManage product from iManage of San Mateo, Calif., which can provide services such as document meta-data tagging, object permissions and access control, document version management, indexing, and/or full text searching. Linked to document management service 9210 can be a collaboration file management service 9212 and/or a content engine file management service 9214, to which a content import & tagging system can be linked.

Also linked to document management service 9210 can be fax/e-mail integration service 9216 and/or replication management service 9218. To document management service 9210 also can be connected an application/template XML processing service 9220, which can be connected to a relational database management system 9230, such as SQL Server 7.0, and to one or more third party system interfaces 9240.

Between document management level 9200 and collaboration services level 9300 can be a unified messaging and asynchronous rules engine 9250.

Included in collaboration services level 9300 can be a security and permissions module 9310, which can include a frame-based permissions component 9312, a role-based permissions component 9314, and/or an object-based permissions component 9316. Also included in collaboration services level 9300 can be a workflow management module 9320 which can be connected to several and/or all of the components of the application services level 9400.

Within application services level 9400 can be a reporting services component 9410, a template management component 9420, a placement engine 9430, a collaboration engine 9440, and/or a knowledge and coaching dashboard 9450. Included in collaboration engine 9440 can be a messaging/threads component 9442, a document management component 9444, and/or an alerts/event manager 9446.

Between application services level 9400 and web services level 9500 can be a localization module 9460 and/or a brand management module 9480.

Web services level 9500 can include an integrated web-based risk management workspace 9510, that can include facilities for HTML, XML, XSL, JavaScript, and/or ASP, etc. Connected to integrated web-based risk management workspace 9510 can be a user authentication/data encryption facility 9520, utilizing protocols such as RSA and/or SSL.

Advantages

There are substantial advantages of the methods and systems of the present invention over the known methods and systems. For example, embodiments of the present invention can enable improved efficiency in the risk and insurance industries. Such efficiency improvements can serve to lower costs, improve quality of service, improve customer relations, and/or improve worker morale.

Still other advantages of the present invention will become readily apparent to those skilled in this art from the above-recited detailed description. Accordingly, the drawings and descriptions are to be regarded as illustrative in nature, and not as restrictive. For example, the embodiments of the computer-aided method for managing a web-enabled collaborative insurance process of the present invention can be adapted to automatically alert an insurer when a request for quotation is posted, or to automatically alert a broker (or any other designated collaborator) when a quote has been posted. As another example, a computer-aided system of the present invention can provide software that compares quotes and recommends a policy based upon pre-selected criteria, including criteria collaboratively selected by the client, the client's advisor, and/or the broker.

What is claimed is:

1. A computer-aided method for managing a web-enabled collaborative insurance process, comprising the activities of:
for each of a plurality of insurance transactions,
for each of a plurality of users,
automatically creating a plurality of standardized computer document folders consistent with a role of the user in a web-enabled collaborative insurance process;
automatically hierarchically organizing the plurality of standardized computer document folders into a folder structure; and
providing the user with access via a networked computer to the user's hierarchically organized folder structure and plurality of standardized computer document folders;
providing an insurance data entry template having a plurality of fields that meet an insurance industry standard for the computerized submission of exposure information; and
receiving the insurance data entry template with data in each of the plurality of fields;
automatically creating a computer-based insurance quotation request based on the insurance data entry template and having a message and a document containing insurance requirements and exposure information;
simultaneously sending by e-mail a hyperlink to the computer-based insurance quotation request to a plurality of insurers; and
representing the insurance transaction as a hyperlinked line item on a computer display.

2. The computer-aided method of claim 1, further comprising:
hyperlinking each represented insurance transaction to a plurality of related messages.

3. A method for operating a networked computer system to manage a web-enabled collaborative insurance process, comprising the activities of:
for each of a plurality of insurance transactions,
for each of a plurality of users,
automatically creating a plurality of standardized computer document folders consistent with a role of the user in a computerized collaborative insurance process;
automatically hierarchically organizing the plurality of standardized computer document folders into a folder structure; and
providing the user with access via a networked computer to the user's hierarchically organized folder structure and plurality of standardized computer document folders;
providing an insurance data entry template having a plurality of fields that meet an insurance industry standard for the computerized submission of exposure information; and
receiving the insurance data entry template with data in each of the plurality of fields;
automatically creating a computer-based insurance quotation request based on the insurance data entry template and having a message and a document containing insurance requirements and exposure information;
simultaneously sending by e-mail a hyperlink to the computer-based insurance quotation request to a plurality of insurers; and
representing the insurance transaction as a hyperlinked line item on a computer display.

4. A method for operating at least one information device having a processor, a memory containing instructions, an input device, an output device, and a network interface, the at least one information device attachable to a network, to manage a web-enabled collaborative insurance process, the method comprising the activities of:
for each of a plurality of insurance transactions,
for each of a plurality of users,
automatically creating a plurality of standardized computer document folders consistent with a role of the user in a web-enabled collaborative insurance process;
automatically hierarchically organizing the plurality of standardized computer document folders into a folder structure; and
providing the user with access via a networked computer to the user's hierarchically organized folder structure and plurality of standardized computer document folders;
providing an insurance data entry template having a plurality of fields that meet an insurance industry standard for the computerized submission of exposure information; and
receiving the insurance data entry template with data in each of the plurality of fields;
automatically creating a computer-based insurance quotation request based on the insurance data entry template and having a message and a document containing insurance requirements and exposure information;
simultaneously sending by e-mail a hyperlink to the computer-based insurance quotation request to a plurality of insurers; and
representing the insurance transaction as a hyperlinked line item on a computer display.

5. A computer-readable medium containing instructions for activities comprising:
for each of a plurality of insurance transactions,
for each of a plurality of users,
automatically creating a plurality of standardized computer document folders consistent with a role of the user in a web-enabled collaborative insurance process;
automatically hierarchically organizing the plurality of standardized computer document folders into a folder structure; and
providing the user with access via a networked computer to the user's hierarchically organized folder structure and plurality of standardized computer document folders;
providing an insurance data entry template having a plurality of fields that meet an insurance industry standard for the computerized submission of exposure information; and
receiving the insurance data entry template with data in each of the plurality of fields;
automatically creating a computer-based insurance quotation request based on the insurance data entry template and having a message and a document containing insurance requirements and exposure information;
simultaneously sending by e-mail a hyperlink to the computer-based insurance quotation request to a plurality of insurers; and
representing the insurance transaction as a hyperlinked line item on a computer display.

6. An information device comprising:
a processor,
a memory containing a plurality of instructions,
an input device,
an output device, and
a network interface,
said information device attachable to a network to manage a web-enabled collaborative insurance process,
said instructions related to activities including:
for each of a plurality of insurance transactions,
for each of a plurality of users,
automatically creating a plurality of standardized computer document folders consistent with a role of the user in a web-enabled collaborative insurance process;
automatically hierarchically organizing the plurality of standardized computer document folders into a folder structure; and
providing the user with access via a networked computer to the user's hierarchically organized folder structure and plurality of standardized computer document folders;
providing an insurance data entry template having a plurality of fields that meet an insurance industry standard for the computerized submission of exposure information; and
receiving the insurance data entry template with data in each of the plurality of fields;
automatically creating a computer-based insurance quotation request based on the insurance data entry template and having a message and a document containing insurance requirements and exposure information;
simultaneously sending by e-mail a hyperlink to the computer-based insurance quotation request to a plurality of insurers; and
representing the insurance transaction as a hyperlinked line item on a computer display.

7. A computer-based system for managing a web-enabled collaborative insurance process, comprising:
for each of a plurality of insurance transactions,
for each of a plurality of users,
means for automatically creating a plurality of standardized computer document folders consistent with a role of the user in a web-enabled collaborative insurance process;
means for automatically hierarchically organizing the plurality of standardized computer document folders into a folder structure; and
means for providing the user with access via a networked computer to the user's hierarchically organized folder structure and plurality of standardized computer document folders;
means for providing an insurance data entry template having a plurality of fields that meet an insurance industry standard for the computerized submission of exposure information; and
means for receiving the insurance data entry template with data in each of the plurality of fields;
means for automatically creating a computer-based insurance quotation request based on the insurance data entry template and having a message and a document containing insurance requirements and exposure information;
means for simultaneously sending by e-mail a hyperlink to the computer-based insurance quotation request to a plurality of insurers; and
means for representing the insurance transaction as a hyperlinked line item on a computer display.

8. A computer-aided method for creating a customized folder structure for a web-enabled collaborative insurance process, comprising the activities of:
for each of a plurality of users,
automatically creating a plurality of standardized folders consistent with a role of the user in a web-enabled collaborative insurance process;
automatically hierarchically organizing the plurality of standardized folders into a folder structure; and
providing the user with access via a networked computer to the user's hierarchically organized folder structure and plurality of standardized folders, and
automatically providing a non-repudiatable audit trail for each insurance transaction associated with the folder structure, the audit trail comprising a visual indicator of a time and a user identity for each user's access of each document and message.

9. The computer-aided method of claim 8, further comprising:
requesting an identity of the user.

10. The computer-aided method of claim 8, further comprising:
requesting the role of the user.

11. The computer-aided method of claim 8, further comprising:
receiving an identity of the user.

12. The computer-aided method of claim 8, further comprising:
receiving the role of the user.

13. The computer-aided method of claim 8, further comprising:
receiving a type of insurance transaction, wherein the plurality of standardized folders are consistent with the type of insurance transaction.

14. The computer-aided method of claim 8, further comprising:
obtaining an identity of the user.

15. The computer-aided method of claim 8, further comprising:
obtaining the role of the user.

16. The computer-aided method of claim 8, further comprising:
automatically assigning security settings to each standardized folder from the plurality of folders in the folder.

17. The computer-aided method of claim 8, further comprising:
identifying the user as a client.

18. The computer-aided method of claim 8, further comprising:
identifying the user as a broker.

19. The computer-aided method of claim 8, further comprising:
identifying the user as an insurer.

20. The computer-aided method of claim 8, further comprising:
receiving from the user an identification of a client.

21. The computer-aided method of claim 8, further comprising:
receiving from the user an applicable policy year.

22. The computer-aided method of claim 8, further comprising:
receiving from the user an identification of a desired action.

23. The computer-aided method of claim 8, further comprising:
receiving from the user a transaction type.

24. The computer-aided method of claim 8, further comprising:
automatically providing a folder for documents.

25. The computer-aided method of claim 8, further comprising:
automatically providing a folder for messages.

26. The computer-aided method of claim 8, further comprising:
automatically providing a folder for templates.

27. The computer-aided method of claim 8, further comprising:
automatically providing a web page customized to the user's role in the web-enabled collaborative insurance process.

28. The computer-aided method of claim 8, further comprising:
automatically providing a web page customized to the user's role in the web-enabled collaborative insurance process, the web page including tabs indicative of aspects of the web-enabled collaborative insurance process.

29. The computer-aided method of claim 8, further comprising:
automatically providing a web page customized to the user's role in the web-enabled collaborative insurance process, the web page including a plurality of tabs, each tab indicative of an aspect of the web-enabled collaborative insurance process, each tab activatable to display a collection of tools relevant to the indicated aspect.

30. The computer-aided method of claim 8, further comprising:
automatically providing a web page customized to the user's role in the web-enabled collaborative insurance process, the web page including the user's hierarchically organized folder structure and plurality of standardized folders.

31. The computer-aided method of claim 8, further comprising:
graphically displaying the audit trail.

32. The computer-aided method of claim 8, further comprising:
automatically providing an audit trail to track messages.

33. The computer-aided method of claim 8, further comprising:
automatically providing an audit trail to track messages associated with the web-enabled collaborative insurance process.

34. The computer-aided method of claim 8, further comprising:
automatically providing an audit trail to track messages associated with a transaction in the web-enabled collaborative insurance process.

35. The computer-aided method of claim 8, further comprising:
automatically providing an audit trail to track documents.

36. The computer-aided method of claim 8, further comprising:
automatically providing an audit trail to track documents associated with the web-enabled collaborative insurance process.

37. The computer-aided method of claim 8, further comprising:
automatically providing an audit trail to track documents associated with a transaction in the web-enabled collaborative insurance process.

38. The computer-aided method of claim 8, further comprising:
automatically providing a non-repudiatable audit trail to track documents associated with a transaction in the web-enabled collaborative insurance process.

39. The computer-aided method of claim 8, wherein the plurality of standardized folders are consistent with a desired type of insurance transaction.

40. The computer-aided method of claim 8, further comprising:
notifying the user of an event in the web-enabled collaborative insurance process.

41. The computer-aided method of claim 8, further comprising:
notifying the user of a collaborative event in the web-enabled collaborative insurance process.

42. A method for operating a networked computer system to create a customized folder structure for a web-enabled collaborative insurance process, comprising the activities of:
for each of a plurality of users,
automatically creating a plurality of standardized folders consistent with a role of the user in a web-enabled collaborative insurance process;
automatically hierarchically organizing the plurality of standardized folders into a folder structure;
providing the user with access via a networked computer to the user's hierarchically organized folder structure and plurality of standardized folders, and
automatically providing a non- repudiatable audit trail for each insurance transaction associated with the folder structure, the audit trail comprising a visual indicator of a time and a user identity for each user's access of each document and message.

43. A computer-readable medium containing instructions for activities comprising:
for each of a plurality of users,
automatically creating a plurality of standardized folders consistent with a role of a user in a web-enabled collaborative insurance process;
automatically hierarchically organizing the plurality of standardized folders into a folder structure;
providing the user with access via a networked computer to the user's hierarchically organized folder structure and plurality of standardized folders, and
automatically providing a non-repudiatable audit trail for each insurance transaction associated with the folder structure, the audit trail comprising a visual indicator of a time and a user identity for each user's access of each document and message.

44. A computer-based system for creating a customized folder structure for a web-enabled collaborative insurance process, comprising:
for each of a plurality of users,
means for automatically creating a plurality of standardized folders consistent with a role of the user in a web-enabled collaborative insurance process;
means for automatically hierarchically organizing the plurality of standardized folders into a folder structure;
means for providing the user with access via a networked computer to the user's hierarchically organized folder structure and plurality of standardized folders, and
means for automatically providing a non-repudiatable audit trail for each insurance transaction associated with the folder structure, the audit trail comprising a visual indicator of a time and a user identity for each user's access of each document and message.

45. A computer-aided method for providing access to a plurality of documents to a plurality of collaborators in a web-enabled collaborative insurance process, comprising the activities of:
acquiring at a computer readable medium an identification of a client from a user;
obtaining at the computer readable medium an indication of the plurality of collaborators; and
receiving at the computer readable medium an denotation of access rights for each collaborator from the plurality of collaborators, and
automatically providing a non-repudiatable audit trail for an insurance transaction, the audit trail comprising a visual indicator of a time and a collaborator identity for each collaborator's access of each document and message associated with the insurance transaction.

46. The computer-aided method of claim 45, further comprising:
notifying each collaborator of an access available to that collaborator.

47. The computer-aided method of claim 45, further comprising:
notifying via e-mail each collaborator of an access available to that collaborator.

48. The computer-aided method of claim 45, further comprising:
notifying via e-mail each collaborator of an access available to that collaborator, the e-mail including a hyperlink activatable to access the plurality of documents.

49. The computer-aided method of claim 45, further comprising:
requesting the identification of the client.

50. The computer-aided method of claim 45, further comprising:
requesting the indication of the plurality of collaborators.

51. The computer-aided method of claim 45, further comprising:
requesting the denotation of access rights.

52. The computer-aided method of claim 45, further comprising:
providing a directory of potential collaborators.

53. The computer-aided method of claim 45, wherein the plurality of collaborators were selected from a directory of potential collaborators.

54. The computer-aided method of claim 45, wherein the indication of the plurality of collaborators includes at least one e-mail address.

55. The computer-aided method of claim 45, wherein the access rights are for an identified document folder.

56. The computer-aided method of claim 45, wherein the access rights are for an identified document.

57. A method for operating a networked computer system to provide access to a plurality of documents to a plurality of collaborators in a web-enabled collaborative insurance process, comprising the activities of:
acquiring at a computer readable medium an identification of a client from a user;
obtaining at the computer readable medium an indication of the plurality of collaborators;
receiving at the computer readable medium an denotation of access rights for each collaborator from the plurality of collaborators, and
automatically providing a non-repudiatable audit trail for an insurance transaction, the audit trail comprising a visual indicator of a time and a collaborator identity for each collaborator's access of each document and message associated with the insurance transaction.

58. A computer-readable medium containing instructions for activities comprising:
acquiring at the computer readable medium an identification of a client from a user;
obtaining at the computer readable medium an indication of a plurality of collaborators;
receiving at the computer readable medium an denotation of access rights for each collaborator from the plurality of collaborators, and
automatically providing a non-repudiatable audit trail for an insurance transaction, the audit trail comprising a visual indicator of a time and a collaborator identity for each collaborator's access of each document and message associated with the insurance transaction.

59. A computer-based system for providing access to a plurality of documents to a plurality of collaborators in a web-enabled collaborative insurance process, comprising:
means for acquiring at a computer readable medium an identification of a client from a user;
means for obtaining at the computer readable medium an indication of the plurality of collaborators;
means for receiving at the computer readable medium an denotation of access rights for each collaborator from the plurality of collaborators, and
means for automatically providing a non-repudiatable audit trail for an insurance transaction, the audit trail comprising a visual indicator of a time and a collaborator identity for each collaborator's access of each document and message associated with the insurance transaction.

60. A computer-aided method for processing insurance exposure information in a web-enabled collaborative insurance process, comprising the activities of:
conditional upon a type of insurance transaction, providing to a first collaborator from a plurality of collaborators an e-mail containing a hyperlink which when activated provides an insurance data entry template having a plurality of fields that meet an insurance industry standard for submission of exposure information, and
receiving the insurance data entry template with data in each of the plurality of fields
updating an audit trail, the audit trail comprising a visual indicator of a time and a collaborator identity for each of the plurality of collaborator's access of the template.

61. The computer-aided method of claim 60, wherein the plurality of fields have names defined by the insurance industry standard.

62. The computer-aided method of claim 60, wherein the plurality of fields have sizes defined by the insurance industry standard.

63. The computer-aided method of claim 60, wherein the plurality of fields have XML tags defined by the insurance industry standard.

64. The computer-aided method of claim 60, wherein the insurance industry standard is an ACORD standard.

65. The computer-aided method of claim 60, wherein the insurance data entry template is provided across a network.

66. The computer-aided method of claim 60, wherein the insurance data entry template is received across a network.

67. A method for operating a networked computer system to process insurance exposure information in a web-enabled collaborative insurance process, comprising the activities of:
conditional upon a type of insurance transaction, providing to a first collaborator from a plurality of collaborators an e-mail containing a hyperlink which when activated provides an insurance data entry template having a plurality of fields that meet an insurance industry standard for submission of exposure information,
receiving the insurance data entry template with data in each of the plurality of fields, and
updating an audit trail, the audit trail comprising a visual indicator of a time and a collaborator identity for each of the plurality of collaborator's access of the template.

68. A computer-readable medium containing instructions for activities comprising:
conditional upon a type of insurance transaction, providing to a first collaborator from a plurality of collaborators an e-mail containing a hyperlink which when activated provides an insurance data entry template having a plurality of fields that meet an insurance industry standard for submission of exposure information,
receiving the insurance data entry template with data in each of the plurality of fields, and
updating an audit trail, the audit trail comprising a visual indicator of a time and a collaborator identity for each of the plurality of collaborator's access of the template.

69. A computer-based system for processing insurance exposure information in a web-enabled collaborative insurance process, comprising:
conditional upon a type of insurance transaction, means for providing to first collaborator from a plurality of collaborators an e-mail containing a hyperlink which when activated provides an insurance data entry template having a plurality of fields that meet an insurance industry standard for submission of exposure information,
means for receiving the insurance data entry template with data in each of the plurality of fields, and
means for updating an audit trail, the audit trail comprising a visual indicator of a time and a collaborator identity for each of the plurality of collaborator's access of the template.

70. A computer-aided method for processing insurance exposure information in a web-enabled collaborative insurance process, comprising the activities of:
receiving from a user an insurance data entry template with data in each of a plurality of fields;
enabling the user to authorize publication of the template and data to a community of collaborators in a web-enabled collaborative insurance process, and
automatically providing a non-repudiatable audit trail, the audit trail comprising a visual indicator of a time and a collaborator identity for each collaborator's access of the template or data.

71. The computer-aided method of claim 70, further comprising receiving authorization to publish the template and data to a community of collaborators in a web-enabled collaborative insurance process.

72. The computer-aided method of claim 70, further comprising publishing the template and data to a community of collaborators in a web-enabled collaborative insurance process.

73. The computer-aided method of claim 70, further comprising tracking data added to the template.

74. The computer-aided method of claim 70, further comprising tracking a source of data added to the template.

75. The computer-aided method of claim 70, further comprising maintaining an audit trail for the data.

76. The computer-aided method of claim 70, further comprising maintaining an audit trail for the template.

77. A method for operating a networked computer system to process insurance exposure information in a web-enabled collaborative insurance process, comprising the activities of:
receiving from a user an insurance data entry template with data in each of a plurality of fields;
enabling the user to authorize publication of the template and data to a community of collaborators in a web-enabled collaborative insurance process, and
automatically providing a non-repudiatable audit trail, the audit trail comprising a visual indicator of a time and a collaborator identity for each collaborator's access of the template or data.

78. A computer-readable medium containing instructions for activities comprising:
receiving from a user an insurance data entry template with data in each of a plurality of fields;
enabling the user to authorize publication of the template and data to a community of collaborators in a web-enabled collaborative insurance process, and
automatically providing a non-repudiatable audit trail, the audit trail comprising a visual indicator of a time and a collaborator identity for each collaborator's access of the template or data.

79. A computer-based system for processing insurance exposure information in a web-enabled collaborative insurance process, comprising the activities of:
means for receiving from a user an insurance data entry template with data in each of a plurality of fields;
means for enabling the user to authorize publication of the template and data to a community of collaborators in a web-enabled collaborative insurance process, and
means for automatically providing a non-repudiatable audit trail, the audit trail comprising a visual indicator of a time and a collaborator identity for each collaborator's access of the template or data.

80. A computer-aided method for structuring an insurance transaction in a web-enabled collaborative insurance process, comprising the activities of:
receiving from a user an indication of a client, a plurality of potential insurers, and a submission;
obtaining from the user insurance requirements and exposure information;
automatically providing to the plurality of potential insurers an e-mail containing a hyperlink which when activated provides the submission, the insurance requirements, and the exposure information; and
updating an audit trail, the audit trail comprising a visual indicator of a time and an insurer identity for any of the potential insurer's access of the submission, the insurance requirements, or the exposure information.

81. A method for operating a networked computer system to structure an insurance transaction in a web-enabled collaborative insurance process, comprising the activities of:
receiving from a user an indication of a client, a plurality of potential insurers, and a submission;
obtaining from the user insurance requirements and exposure information; and
automatically providing to the plurality of potential insurers an e-mail containing a hyperlink which when activated provides the submission, the insurance requirements, and the exposure information; and
updating an audit trail, the audit trail comprising a visual indicator of a time and an insurer identity for any of the potential insurer's access of the submission, the insurance requirements, or the exposure information.

82. A computer-readable medium containing instructions for activities comprising:
receiving from a user an indication of a client, a plurality of potential insurers, and a submission;
obtaining from the user insurance requirements and exposure information; and
automatically providing to the plurality of potential insurers an e-mail containing a hyperlink which when activated provides the submission, the insurance requirements, and the exposure information; and
updating an audit trail, the audit trail comprising a visual indicator of a time and an insurer identity for any of the potential insurer's access of the submission, the insurance requirements, or the exposure information.

83. A computer-based system for structuring an insurance transaction in a web-enabled collaborative insurance process, comprising the activities of:
means for receiving from a user an indication of a client, a plurality of potential insurers, and a submission;
means for obtaining from the user insurance requirements and exposure information; and
means for automatically providing to the plurality of potential insurers an e-mail containing a hyperlink which when activated provides the submission, the insurance requirements, and the exposure information; and
means for updating an audit trail, the audit trail comprising a visual indicator of a time and an insurer identity for any of the potential insurer's access of the submission, the insurance requirements, or the exposure information.

84. A computer-aided method for preparing a insurance quotation request, comprising the activities of:
automatically creating an electronic submission having a message and a document containing insurance requirements and exposure information;
simultaneously sending to a plurality of insurers an e-mail containing a hyperlink which when activated provides the electronic submission; and
updating an audit trail, the audit trail comprising a visual indicator of a time and an insurer identity for each of the plurality of insurer's access of the submission.

85. The computer-aided method of claim 84, further comprising receiving a profile from each member of a set of insurers.

86. The computer-aided method of claim 84, further comprising electronically receiving an editable profile from each member of a set of insurers.

87. The computer-aided method of claim 84, further comprising electronically receiving a continuously editable profile from each member of a set of insurers.

88. The computer-aided method of claim 84, further comprising building a directory of insurers.

89. The computer-aided method of claim 84, further comprising building a directory of insurers based on a profile submitted by each insurer in the directory of insurers.

90. The computer-aided method of claim 84, further comprising building a directory of insurers based on an editable profile electronically submitted by each insurer in the directory of insurers.

91. The computer-aided method of claim 84, further comprising building a directory of insurers based on a profile electronically submitted by each insurer in the directory of insurers, the profile continuously editable by the submitting insurer.

92. The computer-aided method of claim 84, further comprising building a directory of insurers based on a profile electronically submitted by each insurer in the directory of insurers, the profile continuously editable by the submitting insurer, the directory dynamically updateable in response to an edit to any profile.

93. The computer-aided method of claim 84, further comprising providing a group of insurers.

94. The computer-aided method of claim 84, further comprising providing a dynamic directory of insurers.

95. The computer-aided method of claim 84, further comprising providing a dynamic directory listing possible insurers and their capabilities.

96. The computer-aided method of claim 84, further comprising providing a dynamic directory listing possible insurers and their interests.

97. The computer-aided method of claim 84, further comprising providing a dynamic directory listing possible insurers and their ratings.

98. The computer-aided method of claim 84, further comprising suggesting a group of possible insurers.

99. The computer-aided method of claim 84, further comprising suggesting a group of possible insurers based on a response to a query.

100. The computer-aided method of claim 84, further comprising providing a group of suggested insurers.

101. The computer-aided method of claim 84, further comprising providing a group of suggested insurers based at least partially upon a response to a query.

102. The computer-aided method of claim 84, further comprising providing a group of suggested insurers based upon a response to a query.

103. The computer-aided method of claim 84, further comprising suggesting a group of possible insurers.

104. The computer-aided method of claim 84, further comprising providing a profile for each insurer in a group of suggested insurers.

105. The computer-aided method of claim 84, further comprising selecting the plurality of insurers.

106. The computer-aided method of claim 84, further comprising receiving an identity of the plurality of insurers.

107. A method for operating a networked computer system to prepare a insurance quotation request, comprising the activities of:
automatically creating an electronic submission having a message and a document containing insurance requirements and exposure information;
simultaneously sending to a plurality of insurers an e-mail containing a hyperlink which when activated provides the electronic submission; and
updating an audit trail, the audit trail comprising a visual indicator of a time and an insurer identity for each of the plurality of insurer's access of the submission.

108. A computer-readable medium containing instructions for activities comprising:
automatically creating an electronic submission having a message and a document containing insurance requirements and exposure information;
simultaneously sending to a plurality of insurers an e-mail containing a hyperlink which when activated provides the electronic submission; and
updating an audit trail, the audit trail comprising a visual indicator of a time and an insurer identity for each of the plurality of insurer's access of the submission.

109. A computer-based system for preparing a insurance quotation request, comprising the activities of:
means for automatically creating an electronic submission having a message and a document containing insurance requirements and exposure information; and
means for simultaneously sending to a plurality of insurers an e-mail containing a hyperlink which when activated provides the electronic submission; and
means for updating an audit trail, the audit trail comprising a visual indicator of a time and an insurer identity for each of the plurality of insurer's access of the submission.

110. A computer-aided method for electronically rendering a plurality of insurance transactions, comprising the activities of:
representing each insurance transaction from the plurality of insurance transactions as a line item on an electronic display; and
hyperlinking each represented insurance transaction to a plurality of related messages and documents; and
updating an audit trail, the audit trail comprising a visual indicator of a time and an user identity for each of a plurality of user's access of any of the plurality of related messages or documents.

111. The computer-aided method of claim 110, providing electronic access to each represented insurance transaction.

112. The computer-aided method of claim 110, providing invited collaborators with electronic access to each represented insurance transaction.

113. The computer-aided method of claim 110, wherein each of the plurality of related messages is contained in at least one thread.

114. The computer-aided method of claim 110, wherein each line item includes a client name.

115. The computer-aided method of claim 110, wherein each line item includes an insurance coverage type.

116. The computer-aided method of claim 110, wherein each line item includes a status.

117. The computer-aided method of claim 110, wherein each line item includes an insurance quotation status.

118. The computer-aided method of claim 110, wherein each line item is dynamically updated.

119. The computer-aided method of claim 110, further comprising dynamically updating each line item.

120. A method for operating a networked computer system to electronically render a plurality of insurance transactions, comprising the activities of:
representing each insurance transaction from the plurality of insurance transactions as a line item on an electronic display; and
hyperlinking each represented insurance transaction to a plurality of related messages and documents; and
updating an audit trail, the audit trail comprising a visual indicator of a time and an user identity for each of a plurality of user's access of any of the plurality of related messages or documents.

121. A computer-readable medium containing instructions for activities comprising:
representing each insurance transaction from a plurality of insurance transactions as a line item on an electronic display; and
hyperlinking each represented insurance transaction to a plurality of related messages and documents; and
updating an audit trail, the audit trail comprising a visual indicator of a time and an user identity for each of a plurality of user's access of any of the plurality of related messages or documents.

122. A computer-based system for electronically rendering a plurality of insurance transactions, comprising the activities of:
means for representing each insurance transaction from the plurality of insurance transactions as a line item on an electronic display; and
means for hyperlinking each represented insurance transaction to a plurality of related messages and documents; and
means for updating an audit trail, the audit trail comprising a visual indicator of a time and an user identity for each of a plurality of user's access of any of the plurality of related messages or documents.

123. A computer-aided method for filing electronic messages in a web-enabled collaborative insurance process, comprising the activities of:
automatically locating an electronic message hierarchy associated with an insurance transaction, the message hierarchy containing a plurality of electronic messages;
automatically determining an appropriate location in the message hierarchy for a new electronic message;
automatically placing the electronic message in the appropriate location; and
automatically updating a non-repudiatable audit trail associated with the transaction, the audit trail comprising a visual indicator of a time and a user identity for each access of each of the plurality of electronic messages, to reflect an addition of the new electronic message to the message hierarchy.

124. The computer-aided method of claim 123, further comprising updating the audit trail to reflect an addition of the electronic message to the message hierarchy.

125. The computer-aided method of claim 123, wherein the audit trail reflects the location of the electronic message in the message hierarchy.

126. The computer-aided method of claim 123, wherein the electronic message includes a document.

127. The computer-aided method of claim 123, further comprising updating an audit trail to reflect an addition of a document associated with the electronic message to the message hierarchy.

128. The computer-aided method of claim 123, further comprising creating the electronic message.

129. The computer-aided method of claim 123, further comprising receiving the electronic message.

130. The computer-aided method of claim 123, further comprising rendering a dynamic view of the message hierarchy.

131. A method for operating a networked computer system to file electronic messages in a web-enabled collaborative insurance process, comprising the activities of:
automatically locating an electronic message hierarchy associated with an insurance transaction, the message hierarchy containing a plurality of electronic messages;
automatically determining an appropriate location in the message hierarchy for a new electronic message; and
automatically placing the electronic message in the appropriate location; and
automatically updating a non-repudiatable audit trail associated with the transaction, the audit trail comprising a visual indicator of a time and a user identity for each access of each of the plurality of electronic messages, to reflect an addition of the new electronic message to the message hierarchy.

132. A computer-readable medium containing instructions for activities comprising:
automatically locating an electronic message hierarchy associated with an insurance transaction, the message hierarchy containing a plurality of electronic messages;
automatically determining an appropriate location in the message hierarchy for a new electronic message; and
automatically placing the electronic message in the appropriate location; and
automatically updating a non-repudiatable audit trail associated with the transaction, the audit trail comprising a visual indicator of a time and a user identity for each access of each of the plurality of electronic messages, to reflect an addition of the electronic message to the message hierarchy.

133. A computer-based system for filing electronic messages in a web-enabled collaborative insurance process, comprising the activities of:
means for automatically locating an electronic message hierarchy associated with an insurance transaction, the message hierarchy containing a plurality of electronic messages;
means for automatically determining an appropriate location in the message hierarchy for a new electronic message; and
means for automatically placing the electronic message in the appropriate location; and
means for automatically updating a non-repudiatable audit trail associated with the transaction, the audit trail comprising a visual indicator of a time and a user identity for each access of each of the plurality of electronic messages, to reflect an addition of the new electronic message to the message hierarchy.

134. A computer-aided method for tracking activities in a web-enabled collaborative insurance process, comprising the activities of:
for each non-repudiatable archive associated with the web-enabled collaborative insurance process, the archive comprising a visual indicator of a time and a user identity for each access of each of a plurality of electronic messages and documents,
obtaining a client, policy year, and transaction associated with the archive;
automatically maintaining a version history of each of the plurality of messages and documents of the archive; and
automatically relating the archive with a location in an archive hierarchy associated with the client; policy year, and transaction.

135. The computer-aided method of claim 134, further comprising allowing the archive to be recalled by its writer.

136. The computer-aided method of claim 134, further comprising providing an indication of whether a collaborator has opened the archive.

137. The computer-aided method of claim 134, further comprising providing an indication of when a collaborator has opened the archive.

138. The computer-aided method of claim 134, further comprising filing the archive in the location in an archive hierarchy associated with the client; policy year, and transaction.

139. The computer-aided method of claim 134, further comprising linking the archive to the location in an archive hierarchy associated with the client; policy year, and transaction.

140. A method for operating a networked computer system to track activities in a web-enabled collaborative insurance process, comprising the activities of:
for each non-repudiatable archive associated with the web-enabled collaborative insurance process, the archive comprising a visual indicator of a time and a user identity for each access of each of a plurality of electronic messages and documents,
obtaining a client, policy year, and transaction associated with the archive;
automatically maintaining a version history of each of the plurality of messages and documents of the archive; and
automatically relating the archive with a location in an archive hierarchy associated with the client; policy year, and transaction.

141. A computer-readable medium containing instructions for activities comprising:
for each non-repudiatable archive associated with a web-enabled collaborative insurance process, the archive comprising a visual indicator of a time and a user identity for each access of each of a plurality of electronic messages and documents,
obtaining a client, policy year, and transaction associated with the archive;
automatically maintaining a version history of each of the plurality of messages and documents of the archive; and
automatically relating the archive with a location in an archive hierarchy associated with the client; policy year, and transaction.

142. A computer-based system for tracking activities in a web-enabled collaborative insurance process, comprising the activities of:
for each non-repudiatable archive associated with the web-enabled collaborative insurance process, the archive comprising a visual indicator of a time and a user identity for each access of each of a plurality of electronic messages and documents,
means for obtaining a client, policy year, and transaction associated with the archive;
means for automatically maintaining a version history of each of the plurality of messages and documents of the archive; and
means for automatically relating the archive with a location in an archive hierarchy associated with the client; policy year, and transaction.

143. A computer-aided method for managing a web-enabled collaborative insurance process, comprising the activities of:
for each of a plurality of insurance transactions, and for each of a plurality of users,
automatically creating a plurality of standardized computer information folders consistent with a role of the user in a web-enabled collaborative insurance process, said standardized computer information folders containing at least two of documents, messages, and structured data;
providing the user with access to the user's plurality of standardized computer information folders via a hyperlink in an e-mail message displayed to the user on a networked computer; and
automatically updating an audit trail, the audit trail comprising a visual indicator of a time and a user identity for each access of any of the documents, messages, and structured data.

144. A computer-aided method for providing access to a plurality of documents, messages, and structured data to a plurality of collaborators in a web-enabled collaborative insurance process, comprising the activities of:
obtaining at a computer readable medium an indication of the plurality of collaborators in the web-enabled collaborative insurance process;
notifying via e-mail each collaborator from the plurality of collaborators of an access available to that collaborator, the e-mail including a hyperlink activatable to access the plurality of documents, messages, and structured data; and
automatically updating an audit trail, the audit trail comprising a visual indicator of a time and a collaborator identity for each collaborator's access of any of the documents, messages, and structured data.

145. The computer-aided method of claim 144, further comprising:
receiving at the computer readable medium an denotation of access rights for each collaborator from the plurality of collaborators.

146. A computer-aided method for providing access to a plurality of documents, messages, and structured data to a collaborator in a web-enabled collaborative insurance process, comprising the activities of:
obtaining at a computer readable medium an indication of the collaborator in the web-enabled collaborative insurance process; and
notifying the collaborator via e-mail of an access available to the collaborator, the e-mail including a hyperlink activatable to access the plurality of documents, messages, and structured data, and
automatically updating an audit trail, the audit trail comprising a visual indicator of a time and a collaborator identity for each collaborator's access of any of the documents, messages, and structured data.

147. The computer-aided method of claim 146, further comprising:
receiving at the computer readable medium an denotation of access rights for the collaborator.

148. A computer-aided method for providing access to a plurality of documents, messages, and structured data to a collaborator in a web-enabled collaborative insurance process, comprising the activities of:
obtaining an e-mail address of the collaborator in the web-enabled collaborative insurance process;
sending to the collaborator an e-mail containing a hyperlink activatable to access the plurality of documents, messages, and structured data, and
automatically updating an audit trail, the audit trail comprising a visual indicator of a time and a collaborator identity for each collaborator's access of any of the documents, messages, and structured data.

149. A computer-aided method for providing access to electronic information to a collaborator in a web-enabled collaborative insurance process, comprising the activities of:
obtaining an e-mail address of the collaborator in the web-enabled collaborative insurance process;
sending to the collaborator an e-mail containing a hyperlink activatable to access the electronic information; and
tracking access to the electronic information by the collaborator in a non-repudiatable audit trail, the audit trail comprising a visual indicator of a time and a collaborator identity for each collaborator's access of any of the electronic information.

150. The computer-aided method of claim 149, further comprising:
receiving at the computer readable medium a denotation of access rights for the collaborator.

151. The computer-aided method of claim 149, wherein the electronic information includes at least one of a document, a message, and structured data.

152. The computer-aided method of claim 149, wherein the electronic information includes at least one document, at least one message, and structured data.

153. A computer-aided method for creating a customized folder structure for a web-enabled collaborative insurance process, comprising the activities of:
for each of a plurality of users,
automatically creating a plurality of information folders, the plurality of folders consistent with a role of the user in a web-enabled collaborative insurance process; and
automatically providing a non-repudiatable audit trail to track information associated with the plurality of folders and with a transaction in the web-enabled collaborative insurance process, the audit trail comprising a visual indicator of a time and a collaborator identity for each collaborator's access of any of the information.

154. A computer-aided method for creating a customized folder structure for a web-enabled collaborative insurance process, comprising the activities of:
for each of a plurality of users,
automatically creating a plurality of hierarchically-organized information folders, the plurality of folders consistent with a role of the user in a web-enabled collaborative insurance process;
automatically providing a non-repudiatable audit trail to track information associated with the plurality of folders and with a transaction in the web-enabled collaborative insurance process, the audit trail comprising a visual indicator of a time and a collaborator identity for each collaborator's access of any of the information.

155. A computer-aided method for creating a customized folder structure for a web-enabled collaborative insurance process, comprising the activities of:
for each of a plurality of users,
automatically creating a plurality of electronic information folders, the plurality of folders consistent with a role of the user in a web-enabled collaborative insurance process;
automatically providing a non-repudiatable audit trail to track information associated with the plurality of folders and with a transaction in the web-enabled collaborative insurance process, the audit trail comprising a visual indicator of a time and a collaborator identity for each collaborator's access of any of the information.

156. The computer-aided method of claim 155, wherein at least one folder from the plurality of folders includes at least one of documents, messages, and structured data.

157. The computer-aided method of claim 155, wherein the audit trail is graphically displayable.

158. A computer-aided method for managing information in a web-enabled collaborative insurance process, comprising the activities of:
for each of a plurality of users,
automatically rendering a plurality of electronic information folders, the plurality of folders consistent with a role of the user in a web-enabled collaborative insurance process;
automatically updating a non-repudiatable audit trail to reflect a change made by the user to a content of any folder from the plurality of folders, the change associated with a transaction in the web-enabled collaborative insurance process, the audit trail comprising a visual indicator of a time and a collaborator identity for each collaborator's access of any of the content.

159. The computer-aided method of claim 158, wherein at least one folder from the plurality of folders includes at least one of documents, messages, and structured data.

160. The computer-aided method of claim 158, wherein the content includes at least one of a document, a message, and structured data.

161. The computer-aided method of claim 158, wherein the content includes a document and a message.

162. The computer-aided method of claim 158, wherein the content includes a document, a message, and structured data.

163. The computer-aided method of claim 158, wherein the audit trail is graphically displayable.

164. A computer-aided method for managing information in a web-enabled collaborative process, comprising the activities of:
for each of a plurality of users,
automatically rendering a plurality of electronic information folders, the plurality of folders consistent with a role of the user in a web-enabled collaborative process;
automatically updating a non-repudiatable audit trail to reflect a change made by the user to a content of any folder from the plurality of folders, the change associated with a transaction in the web-enabled collaborative process, the audit trail comprising, for each user's access of any of the content, a visual indicator of a time of the access and an identity of the user..

165. The computer-aided method of claim 164, wherein at least one folder from the plurality of folders includes at least one of documents, messages, and structured data.

166. The computer-aided method of claim 164, wherein the content includes at least one of a document, a message, and structured data.

167. The computer-aided method of claim 164, wherein the content includes a document and a message.

168. The computer-aided method of claim 164, wherein the content includes a document, a message, and structured data.

169. The computer-aided method of claim 164, wherein the audit trail is graphically displayable.

170. A computer-aided method for electronically rendering a plurality of insurance transactions, comprising the activities of:
for each insurance transaction of the plurality of insurance transactions:
automatically representing the insurance transaction as a line item on an electronic display;
automatically updating the line item to reflect a change in status of the insurance transaction; and
automatically updating an audit trail, the audit trail comprising a visual indicator of a time and a user identity for each of a plurality of user's access of information associated with the insurance transaction.

171. The computer-aided method of claim 170, further comprising providing a hyperlink in the line item to a plurality of related messages and documents.

172. The computer-aided method of claim 170, further comprising hyperlinking the line item to a plurality of related messages and documents.

173. The computer-aided method of claim 170, notifying a collaborator to the insurance transaction of the change in status of the insurance transaction.

174. The computer-aided method of claim 170, providing an invited collaborator to the insurance transaction with electronic access to the insurance transaction.

175. A computer-aided method for electronically rendering a plurality of transactions, comprising the activities of:
for each transaction of the plurality of transactions:
automatically representing the transaction as a line item on an electronic display, the line item including a hyperlink to at least one folder containing a plurality of messages and documents related to the transaction; and
automatically updating the line item to reflect a change in status of the transaction; and
for each of a plurality of user's access of any of the messages or documents, automatically updating an audit trail, the audit trail comprising a visual indicator of a time of the access and an identity of the user.

176. The computer-aided method of claim 175, notifying a collaborator to the transaction of the change in status of the transaction.
